(19) United States
(12) Patent Application Publication
(10) Pub. No.: US 2005/0210116 A1
(43) Pub. Date: Sep. 22, 2005

(54) Notification and summarization of E-mail messages held in SPAM quarantine

(76) Inventor: Ronald W. Samson, Colts Neck, NJ (US)

Correspondence Address: Charles I. Brodsky, Esq., 2 Bucks Lane, Marlboro, NJ, 07746, US

(21) Appl. No.: 10/805,640

(22) Filed: Mar. 22, 2004

(51) Int. Cl. G06F 15/16; G06F 11/30; H04L 9/00; H04L 9/32; G06F 12/14

(52) U.S. Cl. 709/207; 713/200

(57) ABSTRACT

“False positives” of valid E-mail messages are avoided according to a method which creates a numeric score that represents the probability that the message in question is valid, and then quarantines the message in an area separate from the intended message recipient user's primary in-box for scheduled notification to the user of the presence of possible valid messages for selection.

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to E-mail management, in general, and to SPAM management as employed therein, in particular.

2. Description of the Related Art

As is well known and understood, E-mail has become one of the most important business tools for the modern enterprise. As is also well known and understood, such advancements that have been made in E-mail technologies have led to its being a viable replacement for many of the types of communications that previously were carried by telephone, facsimile or paper. However, many persons and organizations seek to exploit E-mail for their own uses, such as with unsolicited commercial E-mail or SPAM. Such unsolicited commercial E-mail—along with viruses, Trojans and Worms—are well understood to not only threaten one's ability to conduct one's one business in a productive manner, but threaten to shut it down entirely. E-mail borne viruses, for example, do not require any action on a user's part before causing major breakdowns at one extreme, while employees reading and deleting SPAM wastes hours of otherwise useful activity every day, on the other extreme. E-mail management control systems have been proposed to deal with these problems, but by-and-large have not adequately solved the problem.

To be more specific, most solutions that have been proposed involve various types of filtering arrangements—but forget the key elements of required E-mail management through focusing on single aspects of the problem rather than an effective overall solution. Many solutions, furthermore, cause more problems than are solved.
a. ANTI-VIRUS. As respect “anti-virus” proposals, most solutions only scan E-mail for known viruses; if the virus is unknown, then the virus simply proceeds past the anti-virus scanner leaving the system vulnerable until the software vendor updates their virus pattern. Of almost equal importance, moreover, those anti-virus proposals that do block content based on attachment name often go further to quarantine the E-mail or attachment, or even delete the mail entirely. (Where this happens, the system administrator must be able to either allow the attachment, or to delete the quarantined E-mail.)
b. SPAM MANAGEMENT. Most SPAM management solutions, on the other hand, have been developed as “all or nothing” solutions—in which, if mail is identified as SPAM, the mail is (1) tagged as such and sent on to the recipient where the user still must deal with the message; or (2) deleted and not delivered which risks the chance of lost legitimate mail (i.e., a “false” positive). Additionally, when relying on a single method of identifying SPAM, new sending and creation techniques of SPAM require timely and frequent updates of detection methods to maintain the effectiveness of any management system. Where the message identified as SPAM is stored in a quarantine mail area furthermore, a mail administrator is needed to monitor and manage the system, which also requires the end user message recipient to be aware of the missing message.
c. RELAY BLOCKING. Many proposed solutions, unfortunately, rely solely on the use of real time “blacklists” for determining when mail should be accepted by listing SPAM servers both in the United States and Internationally. Many E-mail servers have been determined to be over-zealous in this nature, however, by listing suspected third parties of exploiting the E-mail for their own use and including them on the “blacklist”, or by making it nearly impossible for legitimate organizations to get off the lists when so included. While the use of these lists are a good method to determine the validity of a mail server, there still exists a high loss of legitimate E-mail.

As will be understood by those skilled in the art, at one extreme of these “false positives” is simply a degree of consternation when an E-mail transmission is not responded to (as where the intended message recipient does not even know that an E-mail has been sent), and to the other extreme, where something that should have been done by the message recipient is not done because the message was not received (and where disastrous results could follow). As will be readily apparent, what is required is a refined manner of testing with close scrutinization from the moment a sending mail server connects to the Internet until final delivery to the recipient's mail system of an inbound E-mail.

### SUMMARY OF THE INVENTION

As will become clear from the description, the SPAM control method of the present invention is carried out on the Administrator's own Internet service provider-computer system, away from the recipient's own E-mail server. Because the Administrator's system tracks and quarantines mails of questionable content, the amount of E-mail traffic going to the recipient's mail server is reduced, and the availability of its own Internet connections are increased. Once set up at the Administrator's location—in an arrangement termed “ContentCatcher”—the recipient's mail administrator does not have to take any interactive role, as each recipient will be provided its own Web-based E-mail quarantine area to be easily managed themselves. Interspersed between the sender and the intended recipient, the SPAM control method of the invention will be seen able to notify the recipients of received virus infected E-mail, without the virus infected E-mail ever reaching the recipient's E-mail server. Being provided with the identity of the sender, the recipient can then contact the sender by telephone, for example, requesting that a virus-free message be sent instead. By quarantining the mail at the neutral site of the Administrator's own computers, the control method essentially guarantees that a message cannot be automatically or executed in infecting the recipient's network, while allowing the recipient to receive only those attachments which are desired, and which may be critical to its business. As will be seen, any questionable mail is stored for every recipient in his/her own personal “ContentCatcher” mailbox so that legitimate E-mail won't be lost and so that each recipient can tune his/her settings to insure that only the desired mail gets through.

As will become clear from the following description, the SPAM control method of the invention operates through the use of multiple filters which receive and analyze the E-mail content for such things as characterize SPAM—for example, the amount of flesh tones inside the E-mail, the inclusion of certain words at its headers, the presence of alternating highlighted letters, odd syntaxes, Internet photocolor addresses, etc. To effectuate the system operation, the MX record identifying the message recipient end user's domain is changed so that its E-mail gets routed to the Administrator's computer at the intermediate ISP location where it is analyzed through these filters in an interval of the order of 1¼ to 1½ seconds, hardly noticeable by the user.

As this intermediate location, the SPAM control method of the invention sets a first numeric filtering threshold below which substantially all received E-mail messages are immediately sent to the intended message recipient as legitimate E-mail, and above which substantially all received E-mail messages are temporarily held in quarantine. The method of the invention sets a second numeric filtering threshold, below which those temporarily quarantined E-mail messages are flagged for recipient notification. A time schedule is then set for notifying the intended message recipient of the temporarily quarantined E-mail messages, and creating a summary of the temporarily quarantined E-mail messages by one or both of the sender identification and subject matter content informations. In accordance with the established time schedule, the method then sends an E-mail message to the intended message recipient of the summary created—and enables downloading of all the quarantined E-mail messages to the recipient according to the recipient's selection of the desired sender identification and/or subject matter content information associated with the message summary. In accordance with the preferred embodiment of the invention, the control method further includes the additional step of setting a third numeric filtering threshold above which substantially all E-mail is blocked from reaching the intended message recipient. All such numeric thresholds are established by the filters selected to “score” the components of the received E-mail in serial fashion.

In accordance with the invention, moreover, all these steps are blocked, and the recipient never receives any message where the E-mail is accompanied by a pre-identified virus, or in accordance with the receipt of a message from a pre-identified sender or which contains a pre-identified subject matter, each of which can be selected by the intended message recipient or by the administrator of the control method.

In operation, then, the intended recipient can—at 4:00 p.m., for example, its scheduled time—receive an E-mail message from the remote Administrator's computer advising that four messages have been quarantined in this grey area as representative of received E-mail messages that are neither recognized as being legitimate nor as being obvious SPAM. The recipient can then click to read any or all of the quarantined messages from the Administrator's computer. In accordance with a further teaching of the invention, the recipient's downloading to his/her own domain of the quarantined E-mail message automatically generates a read receipt which, without further effort, is stored in the Administrator's computer database as pre-identified sender or pre-selected subject matter to be thereafter sent immediately to the intended recipient upon receipt, thereby bypassing the previous control method steps of the invention. Such bypassing of the filtering and scoring tests also will be seen to follow where the received E-mail message contains the pre-identified sender codes and pre-identified subject matter informations selected by the intended recipient. These then become part of the recipient's “white list”, as contrasted with its “blacklist” of pre-identified senders and subject matters which the control method of the invention immediately block. The automatic “grey area” notification of the invention also will be seen to operate to delete any quarantined messages if not selected by the intended message recipient within a predetermined time interval—such as 30 days.

In accordance with one filtering and scoring method of the invention, as illustrative, a numerical filtering score below “5” may be set as representative of a legitimate E-mail message for immediate sending to the intended recipient, and a score in excess of “20” may be set as a message to be immediately blocked. Scores of 5-20 thus represent the “grey area” to which the intended recipient will be automatically notified at the time schedule established. “High” scores, for example, may be ascribed to E-mail messages in which the words “penis” and “breast” are included, unless selected to be received as when the intended recipient is a physician whose practice deals with such subjects.

### BRIEF DESCRIPTION OF THE DRAWINGS

These and other features of the invention will be more clearly understood from a consideration of the following description, taken in connection with the accompanying drawings, in which:

FIG. 1 is a flow chart helpful in an understanding of the daily notification and summarization of E-mail messages to be held in a SPAM quarantine by the Control Administrator according to the invention; and

FIG. 2 is a flow chart helpful in an understanding of supplementing “white lists” or “authorized sender” lists upon recipient downloading of a quarantined message.

### DETAILED DESCRIPTION OF THE INVENTION

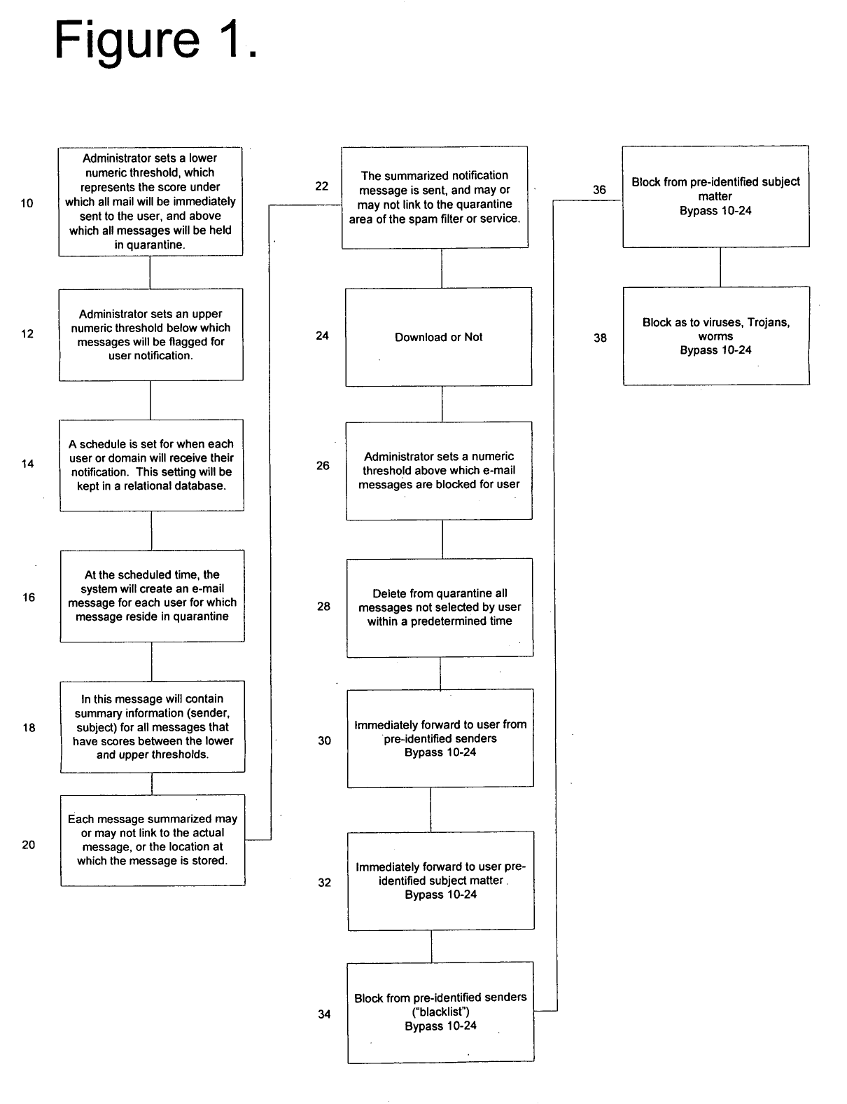

In FIG. 1, the flow chart shown illustrates the SPAM control method of the invention as utilized by the Administrator in which an E-mail filter quarantines the message in an area separate from the intended recipient user's primary in-box by creating a numeric score which represents the probability that the received message is valid or invalid. Thus, Block 10 represents the Administrator setting a first numeric filtering threshold below which the received E-mail messages are immediately sent to the intended message recipient end user, and above which the received E-mail messages are temporarily held in quarantine. Block 12 represents the Administrator setting a second numeric filtering threshold below which temporarily quarantined E-mail messages are flagged for recipient notification at a later time. Block 14 represents the Administrator setting a time schedule for notifying the intended recipient of the temporarily quarantined E-mail messages. Blocks 16 and 18 represent the Administrator creating a summary of the temporarily quarantined E-mail messages at the scheduled time, by at least one of sender identification and subject matter content informations. Block 20 indicates that each summarized message may or may not link to the actual message, or the location at the Administrator's computer where the message is being stored. Block 22 represents the sending of the summarized message to the intended message recipient, where the notification message itself may or may not link to the quarantine area. Block 24 then illustrates the step by which the intended message recipient conditions the Administrator to enable downloading of any and all quarantined E-mail messages according to the recipient's selection of the desired sender identification and/or the subject matter content information within the message summary.

Also shown in the flow chart of FIG. 1 are additional steps embodying the control method of the invention for supplementing and/or bypassing the steps shown as Blocks 10-24. Thus, Block 26 indicates the additional step of the Administrator setting a third numeric filtering threshold above which the received E-mail messages are blocked from reaching the intended message recipient—as where the filtering ascribes scores indicative of SPAM inclusions by flesh tones, the inclusion of certain words, the presence of highlighted letters, odd syntaxes, etc. Block 28 illustrates the added step of deleting from the temporary quarantine all E-mail messages not selected for downloading by the recipient within a predetermined interval of time—as representative of the recipient's lack of interest in messages from that sender and/or messages relating to that subject matter. Block 30, on the other hand, represents the step of bypassing the controls of Blocks 10-24, and immediately sending to the intended message recipient E-mail messages received from a pre-identified sender selected by the recipient, no matter the filtering score determined. Block 32 represents the step of similarly bypassing the controls of Blocks 10-24, and immediately sending to the intended message recipient E-mail messages containing pre-identified subject matter selected by the recipient. The first of these overriding steps may apply, for example, to receive all messages from a child away at school to a parent, while the second may relate to the receipt of desired newsletter information or catalog advertising.

Block 34, moreover, represents a further control step to bypass those of Blocks 10-24, and immediately block E-mail messages received from pre-identified senders selected by the recipient, alone, or in conjunction with the control administrator. Block 36 similarly represents an additional control step to bypass those of Blocks 10-24 in blocking all E-mail messages from reaching the intended message recipient which contain pre-identified subject matter—also, as selected by the recipient, alone or in conjunction with the control administrator. The first of these two control steps may be utilized, for example, in dealing with known SPAM servers in establishing an effective “blacklist”, while the second may be employed in blocking E-mail messages concerning applications for credit card offerings. Block 38, as previously mentioned, represents the control step of bypassing the steps of Blocks 10-24 in blocking all E-mail messages containing viruses, Trojans or Worms as pre-identified by the control administrator.

As will be appreciated by those skilled in the art, any or all of the steps represented by Blocks 26-38 may be combined to work with those of Blocks 10-24, independently or in combination.

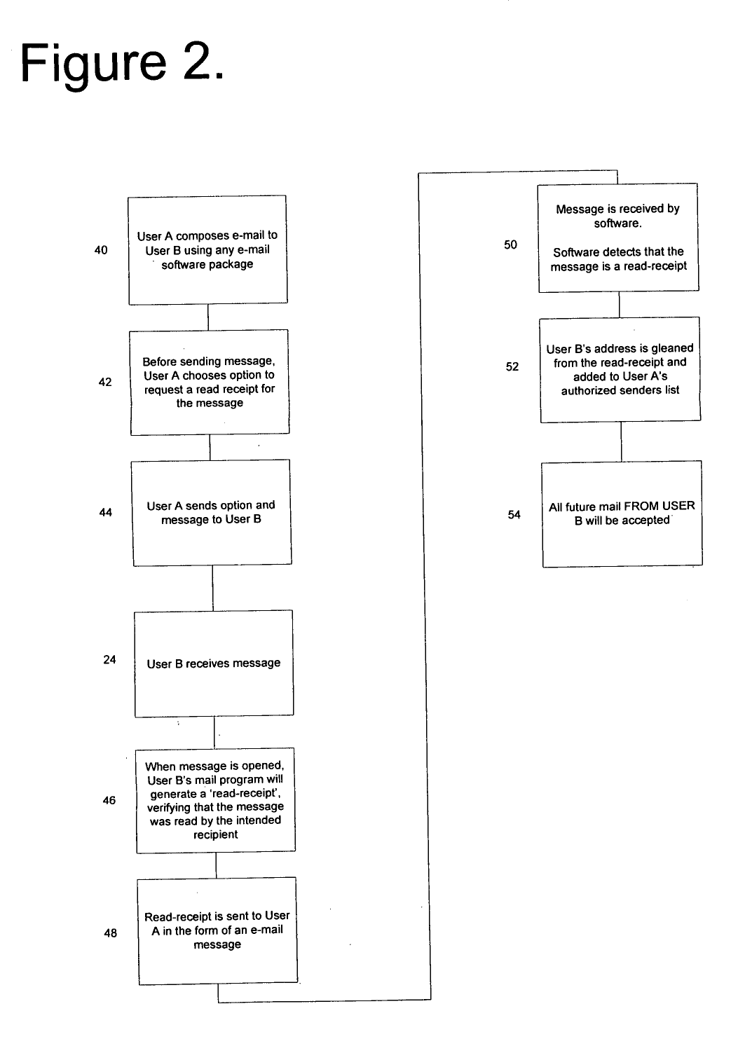

In accordance with the invention, the control steps of Block 24 may be utilized to automatically generate a read-receipt in response to the intended message recipient's selection of desired sender identification in the summarized message. This may be accomplished at the Administrator's location to update its database of “white list” of authorized senders. Thus, in FIG. 2, Block 40 in the flow chart illustrates an instance where user A composes an E-mail message to be sent to user B using any appropriate E-mail software package. Block 42 indicates that before sending the message, user A chooses an option to request an automatic read-receipt for the message—which is then sent along by user A to user B with the message as in the step of Block 44. Corresponding to Block 24 of FIG. 1 where the message recipient effects downloading of the quarantined message, Block 46 shows the step that when the message is opened by user B, its mail program automatically generates this read-receipt verification that the intended message was, in fact, read by the intended recipient. Such read-receipt is sent back to user A in the form of an E-mail message, as in Block 48.

Such message, however, is also sent to the control administrator as in Block 50, where its software detects that the message received is a read-receipt. Block 52 then operates on the read-receipt to add it to user A's authorized sender or “white list”. Block 54 indicates that all future mail from user B will then be accepted as authorized. In like fashion, the control steps of Blocks 40-54 could be utilized by the Administrator to update its control steps so that all E-mail messages received thereafter containing subject matter information selected by the message recipient from the summarized message is added to its database to automatically send E-mail messages of that type to the intended recipient. Bypassing the control steps of Blocks 10-24 of FIG. 1 in this manner similarly follows from the additional generation of a read-receipt when user B downloads the quarantined message as to subject matter content. As will be appreciated, combinations of these two steps could be had depended upon the degree of control desired.

In operation, therefore, every E-mail message received by the “ContentCatcher” of the method goes through a highly refined system of tests from the moment the sending E-mail message connects to the Administrator's server. Only if all the tests are passed does mail get delivered to the intended message recipient end user. In such manner, the SPAM control of the invention obviates the possibility of a loss of legitimate mail while continuing to couple to all legitimate mail that is either intended for, or selected by, the end recipient user.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

1. A SPAM control method for implementation by a SPAM elimination administrator inserted into the signal path between an E-mail sender and its intended message recipient comprising the steps of:
a) Setting a first numeric filtering threshold below which substantially all received E-mail messages are immediately sent to the intended message recipient and above which substantially all received E-mail messages are temporarily held in quarantine;
b) Setting a second numeric filtering threshold below which temporarily quarantined E-mail messages are flagged for intended message recipient notification;
c) Setting a time schedule for notifying the intended message recipient of temporarily quarantined E-mail messages;
d) Creating a summary of said temporarily quarantined E-mail messages by at least one of sender identification and subject matter content informations;
e) Sending an E-mail message to the intended message recipient of said summary in accordance with said time schedule; and
f) Enabling downloading of all quarantined E-mail messages to said intended message recipient according to the recipient's selection of desired sender identification and/or subject matter informations within said message summary.

2. The method of claim 1, also including the step of setting a third numeric filtering threshold above which substantially all received E-mail messages are blocked from reaching said intended message recipient.

3. The method of claim 1, also including the step of deleting from quarantine all E-mail messages not selected for downloading by said intended message recipient according to said identified sender and/or subject matter content information within a predetermined interval of time.

4. The method of claim 1, including the step of bypassing steps a) through f) and immediately sending to said intended message recipient substantially all received E-mail messages received from a pre-identified sender selected by said recipient.

5. The method of claim 1, including the step of bypassing steps a) through f) and immediately sending to said intended message recipient substantially all received E-mail messages containing pre-identified subject matter information selected by said recipient.

6. The method of claim 1, including the step of bypassing steps a) through f) and blocking substantially all received E-mail messages from reaching said intended message recipient from pre-identified senders.

7. The method of claim 1, including the step of bypassing steps a) through f) and blocking substantially all received E-mail messages from reaching said intended message recipient containing pre-identified subject matter.

8. The method of claim 1, including the step of bypassing steps a) through f) and blocking substantially all received E-mail messages from reaching said intended message recipient containing pre-identified viruses.

9. The method of claim 1, including generating a read-receipt in response to said intended message recipient's selection of desired sender identification and/or subject matter content information according to step f).

10. The method of claim 9, including the step of sending said generated read-receipt response to bypass said steps a) through f), and to immediately send said intended message recipient substantially all E-mail messages received thereafter from said identified selected sender.

11. The method of claim 9, including the step of sending said generated read-receipt response to bypass said steps a) through f), and to immediately send said intended message recipient substantially all E-mail message received thereafter containing said selected subject matter information.

12. The method of claim 1, including the steps of setting a third numeric filtering threshold above which substantially all received E-mail messages are blocked from reaching said intended message recipient, and deleting from quarantine all E-mail messages not selected for downloading by said intended message recipient according to said identified sender and/or subject matter content information within a predetermined interval of time.

13. The method of claim 1, also including the steps of bypassing steps a) through f) and immediately sending to said intended message recipient substantially all received E-mail messages received from first pre-identified senders selected by said recipient, bypassing steps a) through f) and immediately sending to said intended message recipient substantially all received E-mail messages containing first pre-identified subject matter information selected by said recipient, bypassing steps a) through f) and blocking substantially all received E-mail messages from reaching said intended message recipient from second pre-identified senders bypassing steps a) through f) and blocking substantially all received E-mail messages from reaching said intended message recipient containing second pre-identified subject matter information, and bypassing steps a) through f) and blocking substantially all received E-mail messages from reaching said intended message recipient containing pre-identified viruses.

14. The method of claim 12, also including the steps of bypassing steps a) through f) and immediately sending to said intended message recipient substantially all received E-mail messages received from first pre-identified senders selected by said recipient, bypassing steps a) through f) and immediately sending to said intended message recipient substantially all received E-mail messages containing first pre-identified subject matter information selected by said recipient, bypassing steps a) through f) and blocking substantially all received E-mail messages from reaching said intended message recipient from second pre-identified senders, bypassing steps a) through f) and blocking substantially all received E-mail messages from reaching said intended message recipient containing second pre-identified subject matter information, and bypassing steps a) through f) and blocking substantially all received E-mail messages from reaching said intended message recipient containing pre-identified viruses.

15. The method of claim 1, including generating a read-receipt in response to said intended message recipient's selection of desired sender identification and/or contained subject matter information according to step f).

16. The method of claim 15, including the step of sending said generated read-receipt response to bypass said steps a) through f), and to immediately send said intended message recipient substantially all E-mail messages received thereafter from said identified selected sender and/or containing said subject matter information.

17. The method of claim 12, including generating a read-receipt in response to said intended message recipient's selection of desired sender identification and/or contained subject matter information according to step f).

18. The method of claim 17, including the step of sending said generated read-receipt response to bypass said steps a) through f), and to immediately send said intended message recipient substantially all E-mail messages received thereafter from said identified selected sender and/or containing said subject matter information.
